(19) United States
(12) Patent Application Publication
(10) Pub. No.: US 2026/0086947 A1
(43) Pub. Date: Mar. 26, 2026

(54) DATA PROCESSING METHOD AND DEVICE THEREOF

(71) Applicant: SAMSUNG ELECTRONICS CO., LTD., Suwon-si (KR)

(72) Inventors: Nannan ZHANG, Suwon-si (KR); Bunjun Kim, Suwon-si (KR); Jungsoo Kim, Suwon-si (KR); Kyungkeun Lee, Suwon-si (KR); Ning Li, Suwon-si (KR); Ran Tan, Suwon-si (KR); Xing He, Suwon-si (KR)

(73) Assignee: SAMSUNG ELECTRONICS CO., LTD., Suwon-si (KR)

(21) Appl. No.: 19/335,817

(22) Filed: Sep. 22, 2025

(30) Foreign Application Priority Data
Sep. 23, 2024 (CN) 202411331272.X

(51) Int. Cl. G06F 12/0871; G06F 12/0808; G06F 12/0868

(52) U.S. Cl. CPC G06F 12/0871; G06F 12/0808; G06F 12/0868; G06F 2212/1016; G06F 2212/262

(57) ABSTRACT

The present disclosure includes a data processing method. The method is executed by one or more processors of a processing near memory (PNM) device, where the PNM device comprises a PNM processor and a cache memory. The method includes pulling, from a memory of a central processing unit of a host associated with the PNM device, strip data related to target data processing and storing the strip data in the cache memory; and pulling, from the cache memory, the strip data strip by strip, and performing the target data processing.

### CROSS-REFERENCES TO RELATED APPLICATIONS

This application claims priority under 35 U.S.C § 119 to Chinese Patent Application No. 202411331272.X filed on Sep. 23, 2024 in the China Intellectual Property Office, the disclosure of which is hereby incorporated by reference in its entirety.

### BACKGROUND

The present disclosure relates to a computer technology field, and in particular, to a data processing method and a device thereof.

A Redundant Array of Independent Disks (RAID) stores same data in different locations on multiple storage devices, such as Solid State Disks (SSDs). This protects the data in an event of a failure of some of the storage devices, and can also be used to improve overall storage performance by aggregating capabilities of the multiple storage devices.

In related art, data is primarily stored in a memory of a Central Processing Unit (CPU). Every time the data is processed, it is necessary to read the data from a memory of a host (i.e., the memory of the CPU), and then a RAID on the CPU operates on the read data. However, a path for the CPU to access the memory of the host is long, i.e., a distance between the CPU and the memory of the host is relatively far, and a time taken by the CPU to read the data from the memory of the host is relatively long, resulting in lower overall data processing efficiency.

### SUMMARY

According to an aspect of the present disclosure, there is provided a data processing method. The method is executed by one or more processors of a processing near memory (PNM) device, where the PNM device comprises a PNM processor and a cache memory. The method includes pulling, from a memory of a central processing unit of a host associated with the PNM device, strip data related to target data processing and storing the strip data in the cache memory; and pulling, from the cache memory, the strip data strip by strip, and performing the target data processing.

According to an aspect of the present disclosure, there is provided a data processing apparatus applied to a processing near memory (PNM) device. The data processing apparatus includes a pulling processor configured to pull, from a memory of a central processing unit of a host associated with the PNM device, strip data related to target data processing and store the strip data in a cache memory; and a data processor configured to pull the strip data from the cache memory strip by strip and perform the target data processing.

According to an aspect of the present disclosure, there is provided a processing near memory (PNM) device. The PNM device includes a PNM processor; and cache memory.

The cache memory is configured to store strip data related to target data processing pulled by the PNM processor from a memory of a central processing unit of a host associated with the PNM device. The PNM processor is configured to pull strip data from the cache memory strip by strip and perform the target data processing.

According to an aspect of the present disclosure, there is provided an electronic device. The electronic device includes a processor; and a memory for storing instructions that may be executed by the processor, wherein the processor is configured to execute the instructions to perform the data processing method according to the present disclosure.

According to an aspect of the present disclosure, there is provided a computer readable storage medium. Instructions stored in the computer readable storage medium, when executed by a processor of an electronic device, cause the electronic device to perform the data processing method according to the present disclosure.

According to an aspect of the present disclosure, there is provided a computer program product including a computer program, wherein the computer program, when executed by a processor, implements the data processing method according to the present disclosure.

### BRIEF DESCRIPTION OF DRAWINGS

The accompanying drawings, which are incorporated in and constitute a part of the specification, illustrate example embodiments consistent with the present disclosure, and together with the specification serve to explain the principles of the present disclosure and do not unduly limit the disclosure.

FIG. 1 is a schematic diagram illustrating a structure of a Redundant Array of Independent Disks (RAID) in related art;

FIG. 2 is a schematic diagram illustrating a structure of a CXL-PNM in related art;

FIG. 3 is a schematic diagram illustrating an implementation process of calculating a redundant data block via a RAID5 in related art;

FIG. 4 is a schematic diagram illustrating an implementation process of data mirroring computation via a RAID1 in related art;

FIG. 5 is a schematic diagram illustrating an implementation process of a write operation via a RAID5 in related art;

FIG. 6 is a schematic diagram illustrating various problems associated with data processing utilizing a RAID in related art;

FIG. 7 is a flowchart illustrating a data processing method according to an exemplary embodiment of the present disclosure;

FIG. 8A is a schematic diagram illustrating a structure of a host in the related art;

FIG. 8B is a schematic diagram illustrating a structure of a data processing device according to an exemplary embodiment of the present disclosure;

FIG. 9 is a schematic diagram illustrating 3 proxies contained in a CPU and 3 compute cores contained in a PNM processor according to an exemplary embodiment of the present disclosure;

FIG. 10 is a schematic diagram illustrating a structure of a compute redundant core according to an exemplary embodiment of the present disclosure;

FIG. 11 is a schematic diagram illustrating a structure of a mirror core according to an exemplary embodiment of the present disclosure;

FIG. 12 is a schematic diagram illustrating a structure of a cache management core according to an exemplary embodiment of the present disclosure;

FIG. 13 is a schematic diagram illustrating a read IO/write IO hit/miss cache according to an exemplary embodiment of the present disclosure;

FIG. 14 is a flowchart illustrating a redundant computation process according to an exemplary embodiment of the present disclosure;

FIG. 15 is a flowchart illustrating a data mirroring computation process according to an exemplary embodiment of the present disclosure;

FIG. 16 is a flowchart illustrating a cache management process according to an exemplary embodiment of the present disclosure;

FIG. 17 is a schematic diagram illustrating a processing near memory device according to an exemplary embodiment of the present disclosure;

FIG. 18 is a block diagram illustrating a data processing apparatus according to an exemplary embodiment of the present disclosure;

FIG. 19 is a block diagram illustrating an electronic device according to an exemplary embodiment of the present disclosure.

### DETAILED DISCLOSURE

In order to make those skilled in the art better understand the technical solutions of the present disclosure, the technical solutions in the embodiments of the present disclosure will be clearly and completely described below with reference to the accompanying drawings.

It should be noted that the terms “first,” “second,” and the like in the description and claims of the present disclosure and the above drawings are used to distinguish similar objects, and are not necessarily used to describe a specific order or sequence. It is to be understood that the data used in this way may be interchanged under appropriate circumstances so that the embodiments of the disclosure described herein can be practiced in orders other than those illustrated or described herein. The implementations described in the following examples are not intended to represent all implementations consistent with the present disclosure. Rather, they are merely examples of apparatus and methods consistent with some aspects of the present disclosure, as recited in the appended claims.

It should be noted here that “at least one of several items” in the present disclosure means including three parallel situations of “any one of the several items,” “a combination of any of the several items,” “the whole of the several items”. For example, “including at least one of A and B” includes the following three parallel situations: (1) including A; (2) including B; (3) including A and B. Another example is “executing at least one of or operation 1 and step 2,” which means the following three parallel situations: (1) executing step 1; (2) executing step 2; (3) executing step 1 and step 2.

The present disclosure provides a data processing method and a device thereof, in order to at least solve the problem in the related art that the overall data processing efficiency is low due to the relatively long time for the CPU to read data from the memory of the host.

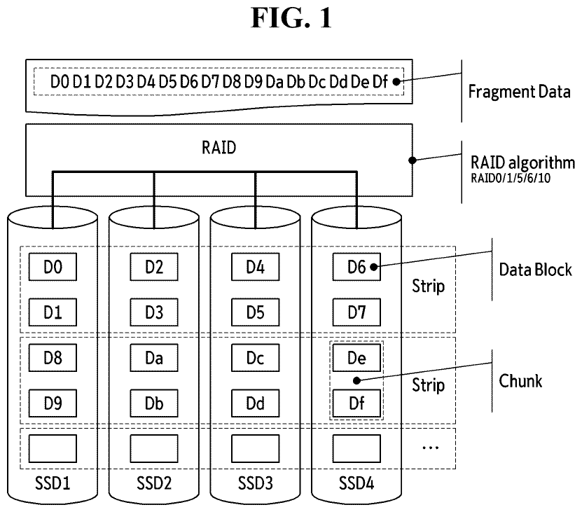

A Redundant Array of Independent Disks (RAID) may divide a storage space of a device into multiple blocks, and blocks from a same storage location on different devices may form a stripe. FIG. 1 is a schematic diagram illustrating a structure of a Redundant Array of Independent Disks (RAID) in the related art. Referring to FIG. 1, the RAID may include four solid state drives (SSDs), respectively a SSD1, a SSD2, a SSD3, a SSD4. Individual data blocks are represented as D0, D1, D2, D3, D4, D5, D6, D7, D8, D9, Da, Db, Dc, Dd, De, and Df.

Among them, eight data blocks of D0, D1, D2, D3, D4, D5, D6, D7 form a data strip (strip1); eight data blocks of D8, D9, Da, Db, Dc, Dd, De, Df form a data strip (strip2).

A striping technology may distribute user data to multiple storage devices (such as SSDs) of the RAID. While this may utilize an aggregated bandwidth of the multiple storage devices for parallel storage; a mirroring technology may also be used instead or in combination with to replicate user data to multiple storage devices for data security. The RAID technology is widely used in data centers. For example, a server operating system may be run on a RAID1, data may be built on a RAID10, a RAID5/RAID6 may build a large-scale high-reliability storage system and so on.

A Processing Near Memory (PNM) is a technology that integrates a logic chip into an advanced integrated circuit package, which may utilize a memory for data computation to reduce data movement between a CPU and the memory. Further, A Compute Express Link (CXL) may be used with the PNM to facilitate expansion of memory capacity. In real testing, a PNM solution based on a CXL interface has been shown to increase application performance by more than two times.

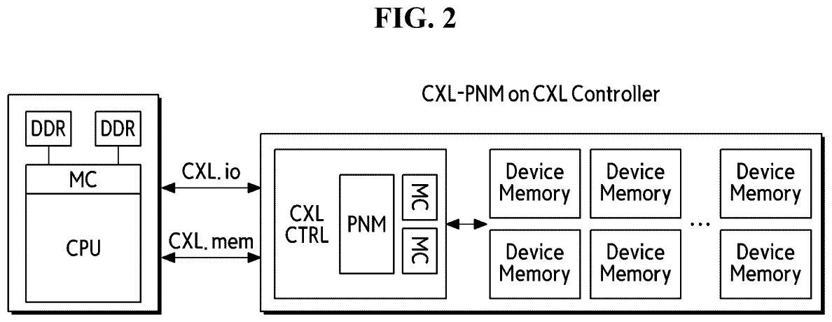

FIG. 2 is a schematic diagram illustrating a structure of a CXL-PNM in the related art. Referring to FIG. 2, a CXL controller (CXL CTRL) may include a PNM as well as a memory controller (MC) of a memory of the PNM. There may be data interaction between the CXL controller and a storage device (or a device memory), and, there may also be data interaction between the CXL controller and a CPU. The components associated with the CPU mainly include a memory controller (MC) of a memory of a host, and a Double Data Rate (DDR).

It should be noted that the RAID is a technology closely related to computing and storage. In the context of explosive growth of data, an increase in computing power of the CPU is gradually slowing down. Especially with the rapid development of high-performance, high-capacity storage devices, such as a SSD of a Non-Volatile Memory express (NVMe) standard, the existing RAID technology is overstretched, mainly in terms of high CPU utilization, high latency of Input/Output (IO), and so on.

In the following, implementation processes of “Data Checking Computation,” “Data Mirroring Computation,” and “Data Modification Computation” and corresponding problems thereof will be introduced with the attached drawings in details.

### Data Checking Computation

During a striping process, the RAID5/6 algorithm may perform a data checking computation to generate a redundant data block of a specific size for each stripe and fill the redundant data block in an appropriate location to recover lost user data.

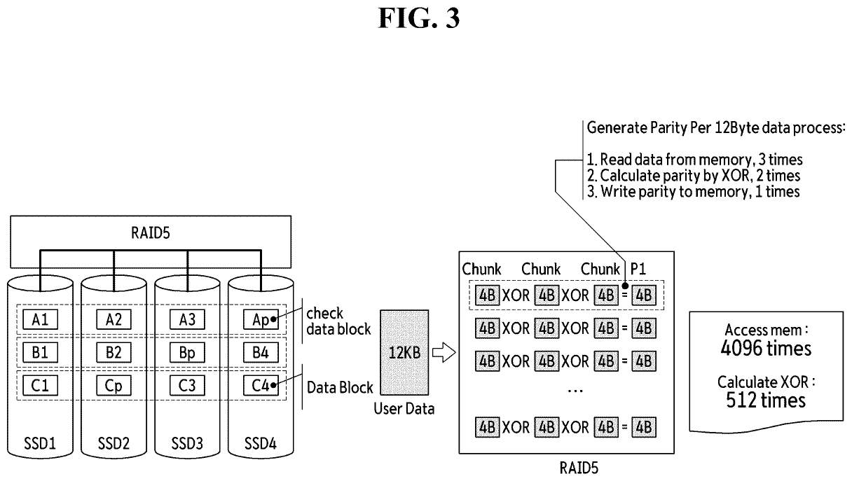

For example, the RAID5 may generate a parity check by utilizing a XOR algorithm. Specifically, in each stripe, a XOR operation may be performed between all data blocks with each other to generate redundant data blocks of a same size, which is a very computationally resource-intensive process. FIG. 3 is a schematic diagram illustrating an implementation process of calculating a redundant data block via a RAID5 in the related art. Referring to FIG. 3, a left side diagram of FIG. 3 illustrates a structure of the RAID5, which contains a total of four SSDs, e.g., a SSD1, a SSD2, a SSD3, and a SSD4. For example, a XOR operation may be performed between a data block A1, a data block A2, and a data block A3 with each other to obtain a redundant data block Ap; a XOR operation may be performed between a data block B1, a data block B2, and a data block B4 to obtain a redundant data block Bp; a XOR operation may be performed between a data block C1, a data block C3, and a data block C4 to obtain a redundant data block Cp. In a right side diagram of FIG. 3, 512 XOR operations and 4,096 memory accesses are required to be performed for user data of a 12 KB size.

As another example, a RAID6 may generate two redundant blocks. Firstly, it may generate a first redundant block like the RAID5; secondly, it may multiply each raw data block by a factor, and then perform a XOR operation, which in turn may generate another redundant data block. As may be seen, the data checking computation of the RAID6 has more than doubled compared to the RAID5.

### Data Mirroring Computation

A “Data mirroring computation” (also referred to as a “data cloning computation”), is a very time-consuming process to clone a large segment of data. In a RAID1/10 algorithm, a mirroring algorithm uses a cloning technique to traverse each stripe, generate a copy for each stripe, and then store the raw data and the cloned copy on different storage devices. The RAID1 may consist of two storage devices, one for storing raw data and the other for storing mirror data.

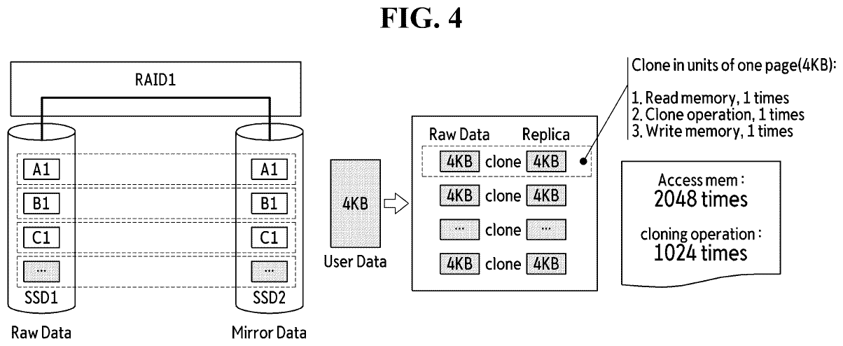

FIG. 4 is a schematic diagram illustrating an implementation process of data mirroring computation via a RAID1 in the related art. Referring to FIG. 4, a left side diagram of FIG. 4 illustrates a structure of the RAID1, and the RAID1 contains a total of two SSDs, namely, a SSD1 and a SSD2. For example, the data cloning computation is performed for a data block A1 stored on the SSD1 to obtain a copy of A1, and the copy of A1 may be stored on the SSD2; the data cloning computation is performed for a data block B1 stored on the SSD1 to obtain a copy of B1, and the copy of B1 is stored on the SSD2; the data cloning computation for a data block C1 stored on the SSD1 may obtain a copy of C1, and the copy of C1 may be stored on the SSD2. In the right diagram of FIGS. 4, 1024 data cloning computations and 2048 memory accesses are required for a segment of user data of a 4MB size. The RAID 10 takes into account both data protection and write performance, but like the RAID 1, it also requires performing cloning in many times.

### Data Modification Computation

Related art has a problem of “random write amplification” in a write data scenario, e.g., in a data modification scenario. Specifically, the RAID is an array of multiple storage devices, such as SSDs, which performs read and write operations on a stripe basis. As a result, a small-size random write IO requires simultaneous updating of redundant data located on another storage device in the stripe. For example, in the RAID5, two additional read IOs and one additional write IO are required if a length of written data is less than a size of a stripe block, i.e., a data block.

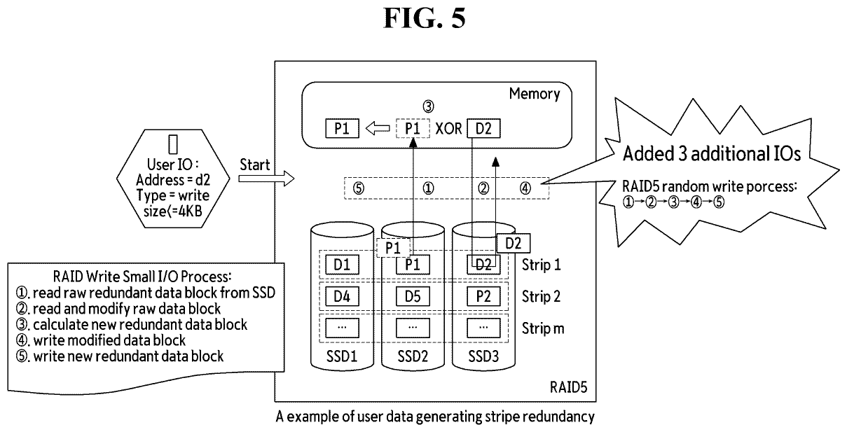

FIG. 5 is a schematic diagram illustrating an implementation process of a write operation via a RAID5 in the related art. Referring to FIG. 5, the RAID5 contains a total of three SSDs, namely, a SSD1, a SSD2, and a SSD3. For example, a XOR operation may be performed between a data block D1 stored on the SSD1 with a data block D2 stored on the SSD3 to obtain a redundant data block P1; a XOR operation may be performed between a data block D4 stored on the SSD1 with a data block D5 stored on the SSD2 to obtain a redundant data block P2.

If a user wants to modify the data block D2, it is necessary to perform of the following operations: (1) reading the raw redundant data block P1 from the SSD2; (2) reading the raw data block D2 from the SSD3, and modifying the raw data block D2 to obtain a modified data block D2′; (3) calculating a new redundant data block P1′ based on the read raw redundant data block P1 and the modified data block D2′: P1 XOR D2′=P1′; (4) writing the modified data block D2′ to the SSD3, i.e., using the modified data block D2′ to overwrite the raw data block D2 which is previously stored on the SSD3; (5) writing the new redundant data block P1′ to the SSD2, i.e. using the new redundant data block P1′ to overwrite the raw redundant data block P1 which is previously stored on the SSD2.

In the above data modification computation process of modifying the data block, the raw data block and the raw redundant data block need to be read first. Then, the modified data block and the new redundant data block need to be written back to the SSD, which generates more additional read IO and write IO. For the RAID6, more IOs will be generated in the process of modifying the data block.

As can be seen, some substantial problems in the related art are time-consuming computations, high latency, and write amplification when processing data. Moreover, because the number of PCIe slots on the host is limited, and if it is desired to realize a function of “expanding the memory,” a separate card is needed to be inserted on the host. Moreover, if it is desired to realize a function of “data checking computation, data cloning computation, data modification computation and cache management,” another separate card is needed to be inserted on the host. Thus, two separate card slots are needed to insert the above two cards. Thus, the related art requires occupying more card slots on the host.

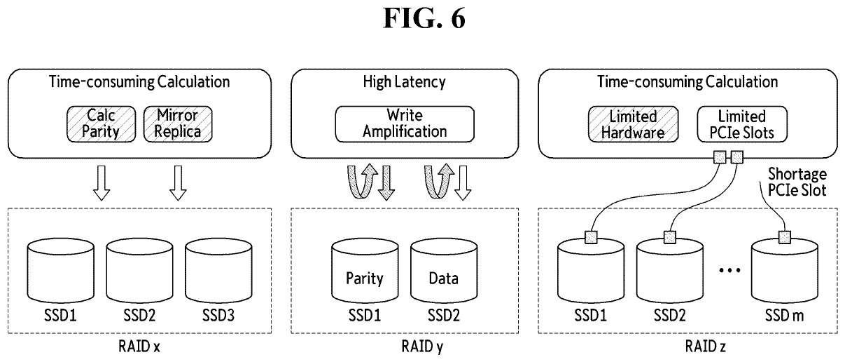

FIG. 6 is a schematic diagram illustrating various problems associated with data processing utilizing a RAID in the related art. Referring to FIG. 6, in the related art, there are problems such as time-consuming computation, high latency, and limited resources when utilizing the RAID associated with data processing.

To solve the above problems in the related art, the data processing method and the device thereof provided by the present disclosure enable a processing near memory (PNM) processor(s) (also referred to herein as a PNM module) to directly pull strip data from a cache memory (also referred to herein as cache module or cache memory associated with the PNM device) strip by strip and perform target data processing by setting the cache memory in the PNM device. Since a distance between the PNM processor and the cache memory is smaller than a distance between the central processing unit and the memory of the central processing unit, reading data from the cache memory by the PNM processor may take less time than reading data from the memory of the host through the central processing unit. This in turn improves the overall data processing efficiency. Further, the occupancy rate of the central processing unit is reduced by moving the time-consuming and intensive data processing process from the central processing unit to the PNM processor. This releases the computing power of the central processing unit.

The technical solutions provided by embodiments of the present disclosure bring at least the following beneficial effects:

In the present disclosure, by setting the cache memory in the PNM device, the PNM processor may directly pull strip data from a cache memory strip by strip and perform target data processing. Since a distance between the PNM processor and the cache memory is smaller than a distance between the central processing unit and the memory of the central processing unit, reading data from the cache memory by the PNM processor may take less time than reading data from the memory of the host through the central processing unit, which in turn may improve the overall data processing efficiency. Further, the occupancy rate of the central processing unit may be reduced by moving the time-consuming and intensive data processing process from the central processing unit to the PNM processor, thereby releasing the computing power of the central processing unit.

According to an exemplary embodiment of the present disclosure, in a case where it is determined that strip data of a certain strip stored in the strip cache has expired, the strip data may be deleted from the strip cache, which in turn may avoid excessive occupation of the strip cache by invalid strip data that has not been accessed for a long period. Further, after the strip data is deleted, the cache bitmap value corresponding to the deleted strip data may be synchronously updated, so that it is easy to determine whether the corresponding strip data exists in the strip cache directly based on the updated cache bitmap value during the subsequent query process, which may improve the query efficiency of the strip data.

According to an exemplary embodiment of the present disclosure, reading data from the cache memory takes less time than reading data from the SSD. Therefore, by moving the check data block corresponding to the deleted strip data into the redundant cache, it is convenient that in a subsequent data writing scenario, that is, a subsequent data modification scenario, the check data block may be read directly from the redundant cache contained in the cache memory, thereby avoiding the problem of long reading time brought by reading the check data block directly from the SSD, and improving the efficiency of reading the check data block.

According to an exemplary embodiment of the present disclosure, compared to directly caching the strip data in the stripe cache, only caching the check data block corresponding to the strip data in the redundant cache may reduce the occupation of the cache space to a larger extent; moreover, if a certain one of cache items in the redundant cache becomes cold, it may be deleted directly, which may avoid the excessive occupation of the redundant cache by the invalid check data block that is not accessed for a long period. Further, because the check data block exists separately in the redundant cache, it is convenient to subsequently read the check data block directly from the redundant cache, i.e., it improves the cache hit rate that may read the check data block directly from the redundant cache, thus avoiding the problem of long reading time brought by reading the check data block directly from the SSD, and improving the reading efficiency of the check data block. As may be seen, the redundant cache set in the cache memory of the present disclosure better realizes a balance between the cache space occupation and the cache hit rate.

It is to be understood that both the foregoing general description and the following detailed description are exemplary and explanatory only and are not restrictive of the present disclosure.

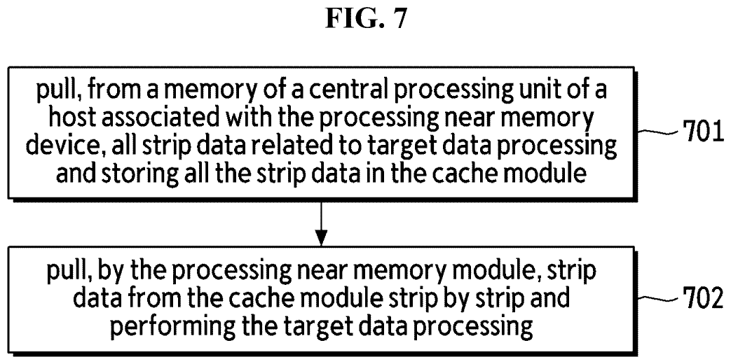

FIG. 7 is a flowchart illustrating a data processing method according to an exemplary embodiment of the present disclosure. The data processing method may be applied to a PNM device (e.g., CXL-PNM device). The PNM device may include a PNM processor and a cache memory (Memory).

Referring to FIG. 7, in operation 701, strip data related to target data processing may be pulled from a memory of a central processing unit of a host associated with the PNM device, and the strip data may be stored in the cache memory. In embodiments, all strip data related to target data processing may be pulled from a memory of a central processing unit of a host associated with the PNM device, and all the strip data may be stored in the cache memory.

In embodiments, the user may input data to be processed to a host, and in turn, a CPU on the host may perform striping processing on the data, e.g., may split the data to be processed that is input by the user into a plurality of small data blocks to obtain stripe data. Then, the CPU may write the stripe data obtained by the splitting into a memory of the host. Then, the CPU may transmit a storage address of the strip data in the memory of the host to the PNM processor. The PNM processor may then pull the strip data from the memory of the host into the cache memory based on the storage address transmitted by the CPU. In the present disclosure, “memory of the host” may also be referred to be the “memory of the CPU”.

According to an exemplary embodiment of the present disclosure, the above data processing method may be performed when the “target data processing” is an intensive computation for a redundant array of independent disks. For example, the “intensive computation for the redundant array of independent disks” may be a computation in which a size of computational resources of the central processing unit required to be occupied exceeds a preset resource size.

According to an exemplary embodiment of the present disclosure, the above “intensive computation for the redundant array of independent disks” may include at least one of a “data checking computation,” a “data cloning computation,” and a “data modification computation”. For example, the “data checking computation” may refer to a computation that performs a XOR operation on a data block contained in stripe data to obtain a check data block. The “data cloning computation” may refer to a computation that performs replication on a data block contained in stripe data to obtain a mirrored replica. As another example, the “data modification computation” may refer to a computation of modifying a data block contained in strip data to obtain a new data block. Furthermore, the “data checking computation” may also be referred to as a “redundant computation,” and the “data cloning computation” may be referred to as the “data mirroring computation” mentioned above.

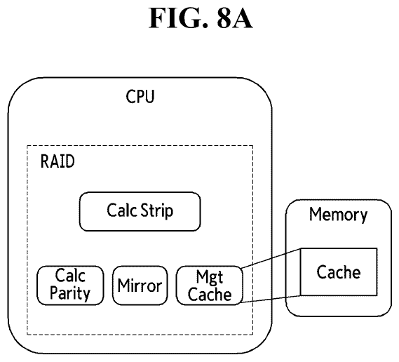

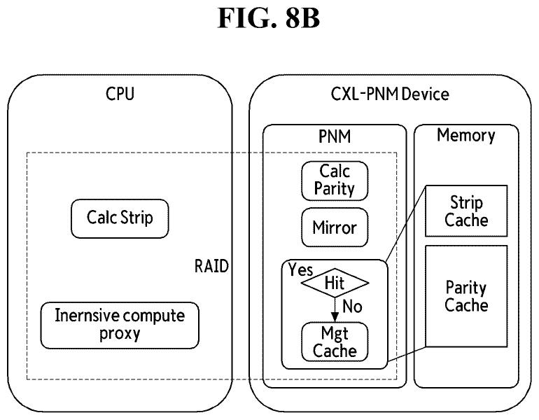

FIG. 8A is a schematic diagram illustrating a structure of a host in the related art and FIG. 8B is a structure of a data processing device according to an exemplary embodiment of the present disclosure. Referring to FIG. 8A, the structure of the host in the related art is shown. The host in the related art may include a CPU and a memory of the host. Moreover, a RAID logic may be realized on the CPU, i.e., the “data checking computation,” the “data cloning computation,” the “data modification computation,” and the “cache computation” may be performed mainly by the CPU in the related art, which leads to high CPU utilization.

The structure of the data processing device according to the exemplary embodiment of the present disclosure is illustrated in FIG. 8B. In the present disclosure, the data processing device may include a CPU and a PNM device. The PNM device may include a PNM processor and cache memory (e.g., memory module in the CXL-PNM device of FIG. 8B). For example, the PNM processor is mainly used to implement the RAID logic, i.e., in the present disclosure, the time-consuming intensive computation process is realized by offloading it from the CPU to the PNM processor, so as to reduce the occupancy rate of the CPU, thereby releasing the computing power of the CPU.

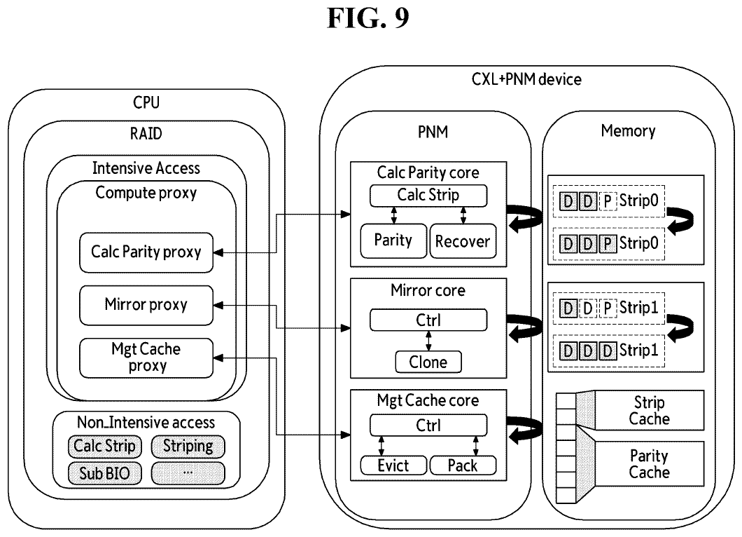

Further, in the present disclosure, the CPU may contain three proxies, namely, a redundant compute proxy “Calc Parity proxy,” a mirror proxy “Mirror proxy” and a cache proxy “Mgt Cache proxy”. Moreover, the PNM processor may contain three compute cores, namely, a compute redundant core “Calc Parity core,” a mirror core “Mirror core” and a cache management core “Mgt Cache core”. FIG. 9 is a schematic diagram illustrating 3 proxies contained in a CPU and 3 compute cores contained in a PNM processor according to an exemplary embodiment of the present disclosure.

For example, the above three proxies in the CPU are responsible for communicating with the compute cores on the PNM, initiating computation, generating and transferring parameters, collecting computation results, and performing subsequent logic processing. For the “redundant compute proxy,” it may be responsible for handling verification code generation, validity verification and data recovery functions of stripe data according to a state of a stripe of the RAID. It may also be responsible for generating and transmitting a computation request to the compute redundant core. The “Mirror Proxy,” may be responsible for generating and transmitting a mirror data request to the mirror core according to a state of a stripe of the RAID to complete generation of a clone strip. The “cache proxy,” may be responsible for maintaining cache validity and write cache block curing according to a cache policy, and requesting the cache management core to clean up invalid cache and packing the write cache data into a larger data block periodically.

It should be noted that each of the above compute cores may include at least one control unit (ctrl) and multiple compute units. For example, the control unit (ctrl) is mainly responsible for interacting with a proxy on the CPU side, executing a computation process, accessing a device memory, and invoking the compute units. And, each compute core may have a single built-in algorithm.

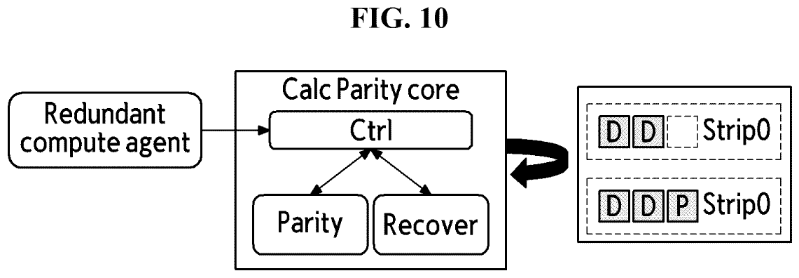

FIG. 10 is a schematic diagram illustrating a structure of a compute redundant core according to an exemplary embodiment of the present disclosure. Referring to FIG. 10, the compute redundant core may be composed of a control unit (ctrl) and one or more compute units. For example, the “control unit (ctrl)” is mainly used for traversing strips and executing a corresponding redundant algorithm according to a RAID level. The compute units may include a “redundant unit (Parity)” and a “recover unit (Recover).” The “redundant unit (Parity)” may be internally provided with a strip redundant algorithm and may be used for performing a redundant computation for a data block contained in the stripe data. The “recover unit (Recover)” may be used to recover a lost data block. In FIG. 10, a data strip Strip0 is shown, which may contain two data blocks, D1 and D2, respectively, and the “redundant unit (Parity)” may perform the redundant computation, i.e., data checking computation, for the two data blocks, thereby obtaining check data block P1 corresponding to the data strip Strip0.

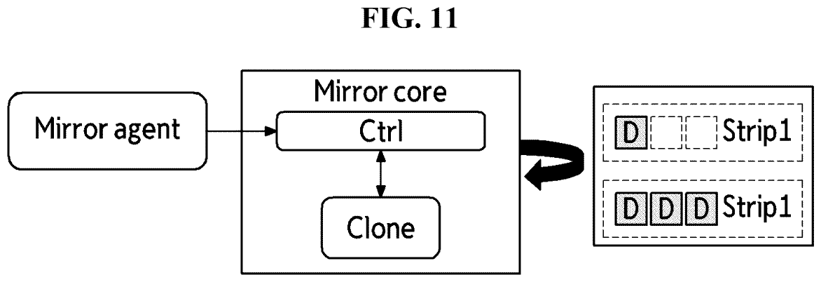

FIG. 11 is a schematic diagram illustrating a structure of a mirror core according to an exemplary embodiment of the present disclosure. Referring to FIG. 11, the mirror core may be composed of a control unit (ctrl) and one or more compute units. For example, the “control unit (ctrl)” may be used for performing cloning tasks for strip blocks in batches. The compute units may include a “clone unit (Clone),” and the “clone unit (Clone)” may be used for realizing a strip cloning algorithm. In FIG. 11, a data strip Strip1 is shown, which may contain a data block D3, and the “clone unit (Clone)” may perform the data mirroring computation, i.e., data cloning computation, for the data block D3, thereby obtaining clone data blocks D3′ and D3″corresponding to the data block D3.

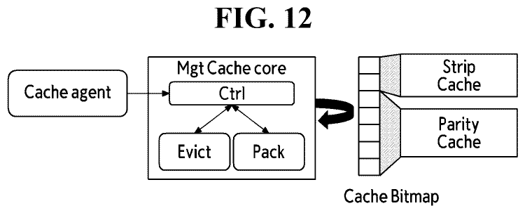

FIG. 12 is a schematic diagram illustrating a structure of a cache management core according to an exemplary embodiment of the present disclosure. Referring to FIG. 12, the cache management core may be composed of a control unit (ctrl) and one or more compute units. For example, the “control unit (ctrl)” may be used to periodically check strips, and evict and merge caches. The one or more compute units may include a “evict unit (Evict)” and a “pack unit (Pack),” with the “evict unit (Evict)” being internally set with a cache policy to maintain cache validity, and the “pack unit (Pack)” being used to organize strip data in accordance with the policy, and then pack it into data blocks suitable for reading and writing by the storage device (such as SSD).

Regarding FIG. 7, in operation 702, the PNM processor may pull stripe data from the cache memory strip by strip and perform the target data processing. For example, the PNM processor may pull the stripe data from the cache memory in a strip by strip manner, and perform the “data checking computation,” the “data cloning computation,” the “data modification computation,” or the “cache management” for the strip data of each pulled strip.

According to an exemplary embodiment of the present disclosure, when the target data processing is the data checking computation, the PNM processor may pull the strip data from the cache memory strip by strip and perform the data checking computation for a data block contained in the strip data that is pulled strip by strip to obtain a check data block corresponding to the strip data that is pulled strip by strip.

For example, the PNM processor may read all data blocks contained in the strip data. Assuming that strip data of a certain strip contains a total of two data blocks, respectively, a data block D1 and a data block D2, the PNM processor may perform the data checking computation for the data blocks D1 and D2 contained in the read strip data. For example, it may perform a XOR operation, and may obtain a check data block P1: D1 XOR D2=P1. Next, the PNM processor may transmit the check data block P1 to the cache memory, and the cache memory may store the received check data block P1 in association with the strip data read this time.

Further, the PNM processor may also transmit the obtained check data block to the CPU, whereby the CPU may write the received check data block to the SSD together with the strip data corresponding to the check data block, i.e., the CPU may write the received check data block to the SSD together with the raw data block used to obtain the check data block.

It should be noted that the PNM processor, while transmitting the check data block to the CPU, may also transmit the corresponding stripe data to the CPU together, so that the CPU may write the received check data block and the corresponding stripe data to the SSD together. In a same or alternate embodiment, the PNM processor may only transmit the check data block to the CPU, and the CPU obtains the corresponding stripe data from the memory of the host by itself and then writes the received check data block to the SSD together with the corresponding stripe data.

According to an exemplary embodiment of the present disclosure, the PNM processor may also receive an algorithm type regarding the checking computation transmitted by the central processing unit. For example, the “algorithm type regarding the checking computation” may be an “algorithm type for the redundant array of independent disks”. Exemplarily, the “algorithm type for the redundant array of independent disks” may be, but is not limited to: a RAID0, a RAID1, a RAID5, a RAID6, a RAID10, etc. Redundant algorithms corresponding to different algorithm types for the redundant array of independent disks may be different. For example, for the RAID5, only one redundant data block, i.e., a check data block P Parity, needs to be calculated; while for the RAID6, two redundant data blocks, P Parity and Q Parity, need to be calculated.

Next, the PNM processor may pull the stripe data strip by strip from the cache memory, and may perform the data checking computation for the data block contained in the stripe data that is pulled strip by strip based on the algorithm type of the checking computation transmitted by the CPU, i.e., the algorithm type for the redundant array of independent disks, to obtain the check data block corresponding to the stripe data pulled strip by strip.

According to an exemplary embodiment of the present disclosure, in embodiments where the target data processing is the data cloning computation, the PNM processor may pull the strip data from the cache memory strip by strip and may perform the data cloning computation for a target data block contained in the strip data pulled strip by strip to obtain a clone data block corresponding to the target data block, i.e., obtain a copy data block corresponding to the target data block. And, the PNM processor may also transmit the clone data block to the cache memory, and thus the cache memory may store the received clone data block in association with the strip data read this time.

Further, the PNM processor may also transmit the obtained clone data block to the CPU, and thus the CPU may write the received clone data block to the SSD together with the strip data corresponding to the clone data block, i.e., the CPU may write the received clone data block to the SSD together with the raw data block used to obtain the clone data block.

It should be noted that the PNM processor, while transmitting the clone data block to the CPU, may also transmit the corresponding stripe data to the CPU together, and then the CPU writes the received clone data block and the corresponding stripe data to the SSD together; alternatively, the PNM processor may only transmit the clone data block to the CPU, and the CPU obtains the corresponding stripe data from the memory of the host by itself and then writes the received clone data block to the SSD together with the corresponding stripe data.

According to an exemplary embodiment of the present disclosure, the PNM processor may determine whether there exists expired strip data in the cache memory, wherein the expired strip data is strip data that has not been accessed within a preset first period. In embodiments where it is determined that there exists the expired strip data, the expired strip data may be deleted from the cache memory and a check data block corresponding to the expired strip data may be retained in the cache memory.

According to an exemplary embodiment of the present disclosure, a cache bitmap value of the deleted strip data may also be modified from a first value to a second value. For example, the first value may be 1; the second value may be 0. Herein, the first value may be used to indicate that the strip data exists in a strip cache and the second value may be used to indicate that the strip data does not exist in the strip cache.

Thus, when it is determined that strip data of a certain strip stored in the cache memory has expired, the strip data may be deleted from the cache memory, which in turn may avoid excessive occupation of the cache memory by invalid strip data that has not been accessed for a long period. Further, after the strip data is deleted, the cache bitmap value corresponding to the deleted strip data may be synchronously updated. Thus, it is easy to determine whether the corresponding strip data exists in the strip cache directly based on the updated cache bitmap value during the subsequent query process, which improves the query efficiency of the strip data.

According to an exemplary embodiment of the present disclosure, referring back to FIG. 8B, the above cache memory may include a first cache area and a second cache area.

Herein, the first cache area may be used to store strip data and a check data block thereof, and the second cache area may be used to store a check data block of deleted strip data. Furthermore, the “first cache area” may be called as the strip cache, and the “second cache area” may be called as a redundant cache or a parity cache.

The expired strip data may be deleted from the first cache area, and the check data block of the expired strip data may be moved from the first cache area to the second cache area. That is, the PNM processor may move the check data block corresponding to the deleted strip data stored in the strip cache to the redundant cache. That also is, in the strip cache, if the hotness of the cached content decreases, only the redundant data block of the cached content may be retained and may be evicted to the redundant cache contained in the cache memory.

It should be noted that reading data from the cache memory takes less time than reading data from the SSD. Therefore, by moving the check data block corresponding to the deleted strip data into the redundant cache, it is convenient that in a subsequent data writing scenario, e.g., a subsequent data modification scenario, the check data block may be read directly from the redundant cache contained in the cache memory. This avoids the problem of long reading time brought by reading the check data block directly from the SSD, and improving the efficiency of reading the check data block.

According to an exemplary embodiment of the present disclosure, the PNM processor may also determine whether there exists an expired check data block in the second cache area. Herein, the expired check data block may be is a check data block that has not been accessed within a preset second period. In embodiments, when it is determined that there exists the expired check data block, the expired check data block may be deleted from the second cache area. For example, in the redundant cache (parity cache), if a cache item stored therein becomes cold, the cache item may be directly deleted.

It should be noted that in the present disclosure, hot strip data may be stored in the strip cache; and strip data that is not so hot, i.e., for “warm” strip data, only a check data block corresponding to the “warm” strip data may be stored in the redundant cache (parity cache). Further, cold strip data may be stored directly in the SSD.

In this way, compared to directly caching the strip data in the stripe cache, only caching the check data block corresponding to the strip data in the redundant cache may reduce the occupation of the cache space to a larger extent. Moreover, if a certain one of cache items in the redundant cache becomes cold, it may be deleted directly, avoiding the excessive occupation of the redundant cache by the invalid check data block that is not accessed for a long period.

Further, because the check data block exists separately in the redundant cache, it is convenient to subsequently read the check data block directly from the redundant cache. This improves the cache hit rate that may read the check data block directly from the redundant cache, and avoids the problem of long reading time brought by reading the check data block directly from the SSD. It also improves the reading efficiency of the check data block. As may be seen, the redundant cache set in the cache memory of the present disclosure better realizes a balance between the cache space occupation and the cache hit rate.

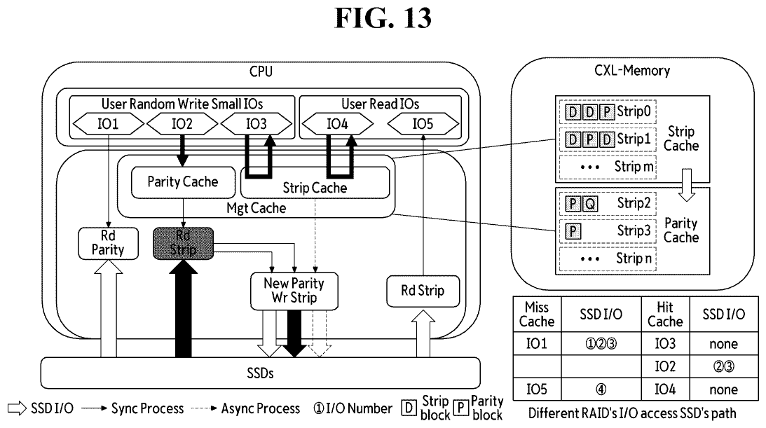

As mentioned above, the modification scenario corresponding to the “data modification computation” may also be referred to as a data writing scenario. FIG. 13 is a schematic diagram illustrating a read IO/write IO hit/miss cache according to an exemplary embodiment of the present disclosure. Referring to FIG. 13, a total of five IOs are illustrated, namely, an IO1, an IO2, an IO3, an IO4, and an IO5, wherein the IO1, the IO2 and the IO3 belong to user random write small IOs; and the IO4 and the IO5 belong to the user read IOs. In FIG. 13, four processes are also shown, namely, (1) reading a check data block from the SSD (Rd Parity); (2) reading a data block contained in stripe data from the SSD (Rd Strip); (3) writing a new check data block and a modified data block to the SSD (New Parity, Wr Strip); and (4) reading the stripe data from the SSD (Rd Strip).

As mentioned above, compared to reading data from the SSD, reading data from the cache memory takes less time, i.e., compared to reading data directly from the SSD, reading data from the strip cache/redundant cache (parity cache) takes less time.

For the write IO1, it includes three processes (1), (2) and (3), i.e., the write IO1 needs to read a raw data block contained in strip data and a raw check data blocks from the SSD. Then, the write IO1 needs to modify the raw data block read from the SSD to obtain a modified data block. Next, the write IO1 also needs to perform a XOR operation between the modified data block and the raw check data block read from the SSD to obtain a new check data block.

Then, the write IO1 needs to write the modified data block and the new check data block into the SSD again, i.e., the write IO1 needs to use the modified data block and the new check data block to overwrite the raw data block and the raw check data block previously stored in the SSD.

For the write IO2, it includes two processes (2) and (3). Specifically, the write IO2 needs to read a raw data block contained in stripe data from the SSD, and the write IO2 may read a raw check data block from the redundant cache (parity cache). Next, the write IO2 needs to modify the raw data block read from the SSD to obtain a modified data block. Then, the write IO2 needs to perform a XOR operation between the modified data block and the raw check data block read from the redundant cache (parity cache) to obtain a new check data block. Then, the write IO2 needs to write the modified data block and the new check data block to the SSD again, i.e., the write IO2 needs to use the modified data block and the new check data block to overwrite the raw data block and the raw check data block previously stored in the SSD. As may be seen, compared with the write IO1, the write IO2 hits the redundant cache, so the overall writing efficiency of the write IO2 is higher than the overall writing efficiency of the write IO1.

For the write IO3, the write IO3 may read a raw data block and a raw check data block from the strip cache. Then, the write IO3 needs to modify the raw data block read from the strip cache to obtain a modified data block. Then, the write IO3 also needs to perform a XOR operation between the modified data block and the raw check data block read from the strip cache to obtain a new check data block. As may be seen, for both the process of reading the raw data block and the process of reading the raw check data block, the write IO3 does not access the storage devices (SSDs), i.e., the write IO3 hits the strip cache, thus eliminating write amplification, i.e., the overall writing efficiency of the write IO3 is higher than the overall writing efficiency of the write IO1 and the write IO2.

For the read IO5, it includes a process of (4). Specifically, the read IO5 needs to read strip data from the SSD; for the read IO4, the read IO4 may read strip data from the Strip Cache. As may be seen, the read IO4 hits the strip cache. Therefore, the overall read efficiency of the read IO4 is higher than the overall read efficiency of the read IO5.

As may be seen from the above analysis, in the present disclosure, by expanding the cache, i.e., by setting the strip cache and the redundant cache (parity cache), the cache hit rate may be improved, which in turn may effectively reduce the read/write latency of the RAID, i.e., write amplification may be effectively avoided, and the data processing efficiency may be improved.

According to an exemplary embodiment of the present disclosure, the PNM processor may pack all the stripe data and all data processing results thereof to obtain packed data, and may transmit the packed data to the central processing unit. The central processing unit may then write the packed data into a storage device of the host associated with the PNM device, e.g., to the SSD of the host. That is, in a writing scenario, the cache strip may be packed into a larger data block and written to the storage device (SSD) of the host.

It is to be noted that, referring back to FIG. 1, two data strips are illustrated in FIG. 1, respectively the strip1 and the strip2. If the packing operation is not performed for the strip1 and the strip2, when the data block D0 and the data block D1 are contained in the data strip strip1, and the data block D8 and the data block D9 contained in the data strip strip2, and are written to the SSD1, then one write operation needs to be performed for each data block, i.e., a total of four write operations need to be performed.

If the packing operation is performed for the strip1 and the strip2, the data block D0, the data block D1, both contained in the data strip strip1, and the data block D8, the data block D9, both contained in the data strip strip2 are packed into a larger data block. At this time, only the larger data block needs to be written to the SSD1, i.e., only one write operation needs to be performed for the larger data block at this time. As may be seen, compared to the method of not packing the data strips, packing the data strips and then writing them to the SSD may greatly reduce the number of write operations, i.e., may greatly improve the writing efficiency.

It should be noted that, in the related art, if it is desired to realize the function of “expanding the memory,” it is necessary to insert a separate card in the host; moreover, if it is desired to realize the function of “data checking computation, data cloning computation, data modification computation and cache management,” it is necessary to insert another separate card in the host. In this case, two separate card slots on the host are required to insert the above two cards.

In the present disclosure, since the processing near memory (PNM) processor and the cache memory (memory) are set in the same device (a CXL-PNM device), the present disclosure requires only one slot on the host for inserting the CXL-PNM device, and thus the function of “expanding the memory” and the function of “data checking computation, data cloning computation, data modification computation and cache management” may be realized. As may be seen, the present disclosure may save the occupation of card slots on the host compared with related art.

Further, if the host contains different types of SSDs, in the related art, it is necessary to insert a corresponding RAID card on the host for each type of SSD to provide a RAID service for that type of SSD. Exemplarily, it is assumed that the host contains a total of three types of SSDs, namely, a PCIe-type of SSD, a SARS-type of SSD, and a SATA-type of SSD, it is necessary in the art to insert a corresponding RAID card into the host for each of the three types of SSDs to provide a RAID service for that type of SSD.

In the present disclosure, regardless of how many different types of SSDs are included on the host, only one CXL-PNM device needs to be inserted on the host to provide RAID services for the different types of SSDs on the host, which may effectively save the use of RAID cards and save hardware costs.

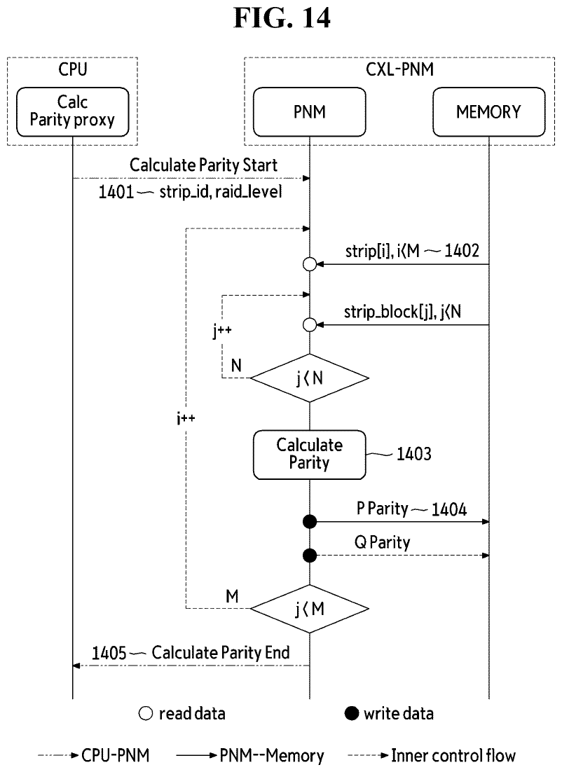

FIG. 14 is an exemplary implementation flowchart illustrating a redundant computation process according to an exemplary embodiment of the present disclosure.

Referring to FIG. 14, in operation 1401, a CPU on a host transmits storage addresses (strip-ids) of a plurality of stripe data and an algorithm type of a redundant array of independent disks (RAID-level) to a processing near memory (PNM) processor of a CXL-PNM Device.

Specifically, a user may input data to be processed to the host, and then the CPU on the host may perform striping processing for the data to be processed input by the user, i.e., it may split the data to be processed input by the user into a plurality of small data blocks to obtain stripe data. Then, the CPU may write the stripe data obtained by the splitting into a memory of the host. Then, the CPU may transmit a storage address of the strip data in the memory of the host to the PNM processor. The PNM processor may then pull the strip data from the memory of the host into the cache memory (memory) based on the storage address transmitted by the CPU.

In operation 1402, the PNM processor pulls strip data from the cache memory strip by strip.

As an example, for strip data strip[i], i<M, the PNM processor may read, from the cache memory, N data blocks strip-block[j](j<N) contained in the strip data strip[i] one by one, where M is the total number of strip data stored in the cache memory.

In operation 1403, the PNM processor, based on an algorithm type for the redundant array of independent disks (RAID-level) transmitted by the CPU on the host, performs a redundant computation for the N data blocks contained in the stripe data strip[i], and obtains a redundant data block (i.e., a check data block) corresponding to the stripe data strip[i].

Exemplarily, it is assumed that the above RAID-level is a RAID6, the PNM processor may calculate two redundant data blocks corresponding to the strip data strip[i], namely, P Parity and Q Parity.

In operation 1404, the PNM processor may transmit the calculated redundant data blocks to the cache memory. In this way, the cache memory may store the received redundant data block in association with the strip data strip[i] used to obtain the redundant data block.

In operation 1405, the processing near memory (PNM) processor transmits a completion message to a redundant compute proxy “Calc Parity Proxy” on the CPU of the host.

Thus, in the present disclosure, by transferring the time-consuming data checking computation process from the central processing unit to the PNM processor, the frequency of the CPU accessing the memory of the host is reduced, and the occupancy rate of the central processing unit may be reduced to release the computing power of the central processing unit.

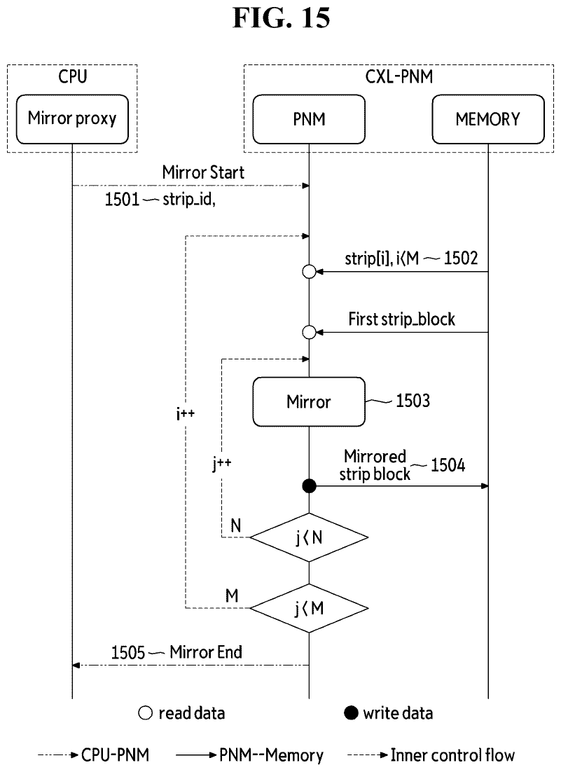

FIG. 15 is an exemplary implementation flowchart illustrating a data mirroring computation process according to an exemplary embodiment of the present disclosure.

Referring to FIG. 15, in operation 1501, a CPU on a host transmits storage addresses (strip-ids) of a plurality of strips data to a processing near memory (PNM) processor of a CXL-PNM Device.

For example, a user may input data to be processed to the host, and then the CPU on the host may perform striping processing for the data to be processed input by the user. E.g., the CPU may split the data to be processed input by the user into a plurality of small data blocks to obtain stripe data. Then, the CPU may write the stripe data obtained by the splitting into a memory of the host. Next, the CPU may transmit a storage address of the strip data in the memory of the host to the PNM processor. The PNM processor may then pull the strip data from the memory of the host into the cache memory (memory) based on the storage address transmitted by the CPU.

In operation 1502, the PNM processor pulls stripe data from the cache memory strip by strip.

For example, for strip data strip[i], i<M, the PNM processor may read, from the cache memory, N data blocks strip-block[j](j<N) contained in the strip data strip[i] one by one, where M is the total number of strip data stored in the cache memory.

In operation 1503, the PNM processor performs a data cloning computation for each data block strip-block[j] contained in the strip data strip[i] to obtain a clone data block corresponding to the data block strip-block[j], i.e., a cloned copy.

In operation 1504, the PNM processor transmits the clone data block corresponding to each data block strip-block[j] to the cache memory. In this way, the cache memory may store the received clone data block in association with the strip data strip[i] used to obtain the clone data block.

In operation 1505, the processing near memory (PNM) processor transmits a completion message to a mirror proxy “Mirror Proxy” on the CPU of the host.

Thus, in the present disclosure, by transferring the time-consuming data cloning process from the central processing unit to the PNM processor, the frequency of the CPU accessing the memory of the host is reduced, and the occupancy rate of the central processing unit may be reduced to release the computing power of the central processing unit.

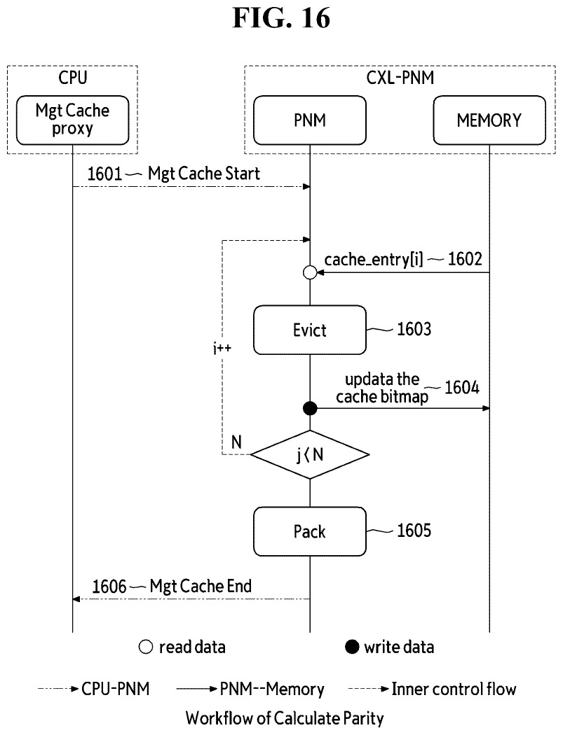

FIG. 16 is an exemplary implementation flowchart illustrating a cache management process according to an exemplary embodiment of the present disclosure.

Referring to FIG. 16, in operation 1601, a CPU on a host transmits a cache management indication message to a processing near memory (PNM) processor. It should be noted that the cache management may be triggered by the CPU, or the cache management may be performed automatically by the processing near memory (PNM) processor at preset time intervals, and the present disclosure does not make any specific limitations thereon.

In operation 1602, the processing near memory (PNM) processor pulls a cache entry cache-entry[i](i<M) from the cache memory (memory) strip by strip, where M is the total number of cache entries stored in the cache memory.

In operation 1603, the processing near memory (PNM) processor determines whether the pulled cache entry cache-entry[i] is expired. In embodiments where it is determined the pulled cache entry cache-entry[i] is expired, the cache entry cache-entry[i] is deleted (evicted) from the cache memory. If a cache entry stored in the cache memory has not been accessed for a long time, the cache entry may be considered to have expired.

In operation 1604, the processing near memory (PNM) processor modifies a cache bitmap value of the deleted cache entry from a first value to a second value.

Herein, the first value may be used to indicate that the cache entry exists in the cache memory, and the second value may be used to indicate that the cache entry does not exist in the cache memory. For example, the first value may be 1 and the second value may be 0.

In operation 1605, the processing near memory (PNM) processor may pack the plurality of cache entries cached within the cache memory and the data processing results thereof to obtain packed data, and may transmit the packed data to the central processing unit, such that the central processing unit may write the packed data to a storage device (SSD) of the host associated with the PNM device (CXL-PNM Device).

In operation 1606, the processing near memory (PNM) processor transmits a completion message to a cache management proxy (Mgt Cache Proxy) on the CPU of the host.

Thus, in the present disclosure, when it is determined that a cache entry stored in the stripe cache has expired, the cache entry may be deleted from the stripe cache. This avoids excessive occupation of the stripe cache by invalid cache entries that have not been accessed for a long period. Further, after the cache entry is deleted, the cache bitmap value corresponding to the deleted cache entry may be synchronously updated, so that it is easy to determine whether the corresponding cache entry exists in the strip cache directly based on the updated cache bitmap value during the subsequent query process. Thus improving the query efficiency of the cache entry. Further, the data strips may be packed and then written to the SSD, which may greatly reduce the number of write operations, i.e., may greatly improve the writing efficiency.

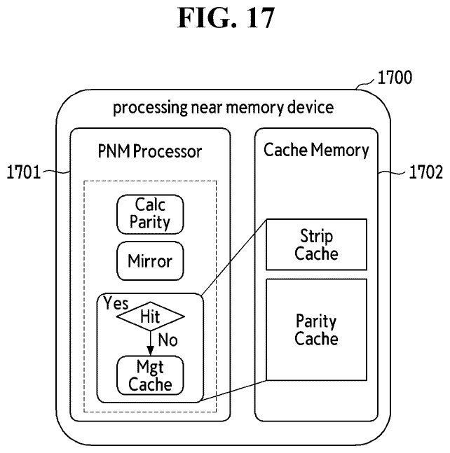

FIG. 17 is a schematic diagram illustrating a PNM device 1700 according to an exemplary embodiment of the present disclosure. Referring to FIG. 17, the PNM device 1700 may include a PNM processor 1701 and a cache memory 1702.

Herein, the cache memory 1702 is used to store all strip data related to target data processing pulled by the PNM processor 1701 from a memory of a central processing unit of a host associated with the PNM device 1700. The PNM processor 1701 is used to pull strip data from the cache memory 1702 strip by strip and perform the target data processing.

Specifically, the PNM processor 1701 may be used to perform a data checking computation (Calc Parity), which is a redundant computation; a data mirroring computation (Mirror), which is a data cloning computation (Clone); a data modification computation; and cache management (Mgt Cache). The cache memory 1702 may include a strip cache and a redundant cache (parity cache). The strip cache is used to cache strip data and a check data block of the strip data; the redundant cache is used to cache only the check data block of the strip data.

In embodiments where the PNM processor 1701 determines that strip data of a certain strip in the strip cache is expired, the strip data may be deleted from the strip cache, and a check data block corresponding to the deleted strip data may be moved to the redundant cache. In the same or different embodiment where the PNM processor 1701 determines that a certain check data block in the redundant cache has expired, the check data block may be deleted from the redundant cache.

According to an exemplary embodiment of the present disclosure, in a modification/reading scenario, the PNM processor 1701 may also be used to determine whether current strip data to be modified/to be read hits the strip cache, and to determine whether a current check data block to be read hits the redundant cache. When hitting the stripe cache, processing may be performed directly on the stripe data and the check data block read from the stripe cache; or, when hitting the redundant cache, processing may be performed directly on the check data block read from the redundant cache. Compared to the method of reading the stripe data and the check data block directly from the SSD, reading the stripe data and the check data block from the cache memory takes less time and the overall data processing efficiency is higher.

According to an exemplary embodiment of the present disclosure, in the modification/reading scenario, in a case of not hitting the cache, i.e., not hitting the stripe cache/redundant cache, the PNM processor 1701 needs to read the stripe data and the check data block from the SSD for subsequent processing.

Thus, in the present disclosure, since the time-consuming and intensive data processing process is moved from the central processing unit to the PNM processor of the PNM device, the occupancy rate of the central processing unit may be reduced to release the computing power of the central processing unit.

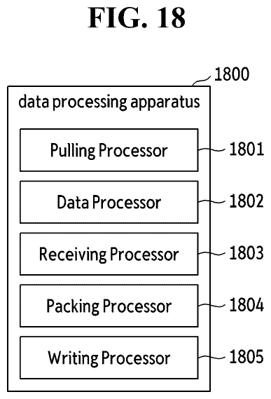

FIG. 18 is a block diagram illustrating a data processing apparatus 1800 according to an exemplary embodiment of the present disclosure. The data processing apparatus 1800 may be applied to a PNM device. The data processing apparatus 1800 may include a pulling processor 1801 (also referred to herein as pulling module) and a data processor 1802.

The pulling processor 1801 may pull, from a memory of a central processing unit of a host associated with the PNM device, all strip data related to target data processing and store all the strip data in the cache memory.

According to an exemplary embodiment of the present disclosure, in a case where the above “target data processing” is an intensive computation for a redundant array of independent disks, the data processing apparatus 1800 may perform operations, i.e., it may perform the above data processing method. For example, the “intensive computation for the redundant array of independent disks” may be a computation in which a size of computational resources of the central processing unit required to be occupied exceeds a preset resource size.

According to an exemplary embodiment of the present disclosure, the above “intensive computation for the redundant array of independent disks” may include at least one of a “data checking computation,” a “data cloning computation,” and a “data modification computation”. For example, the “data checking computation” may refer to a computation that performs a XOR operation on a data block contained in stripe data to obtain a check data block; the “data cloning computation” may refer to a computation that performs replication on a data block contained in stripe data to obtain a mirrored replica; and the “data modification computation” may refer to a computation of modifying a data block contained in strip data to obtain a new data block. Furthermore, the “data checking computation” may also be referred to as a “redundant computation,” and the “data cloning computation” is the “data mirroring computation” mentioned above.

The data processor 1802 (also referred to herein as data processing module) may pull, by the PNM processor, strip data from the cache memory strip by strip and perform the target data processing. For example, the PNM processor may pull the stripe data from the cache memory strip by strip, and perform the “data checking computation,” the “data cloning computation,” the “data modification computation,” or the “cache management” for the strip data of each pulled strip.

According to an exemplary embodiment of the present disclosure, in a case where the target data processing is the data checking computation, the data processor 1802 may perform the data checking computation for a data block contained in the strip data pulled strip by strip to obtain a check data block corresponding to the strip data pulled strip by strip.

According to an exemplary embodiment of the present disclosure, the above data processing apparatus 1800 may further include receiving processor 1803 (also referred to as receiving module or receiver) that may be configured to receive, by the PNM processor, an algorithm type regarding the checking computation transmitted by the central processing unit. Wherein, the “algorithm type for the checking computation” may be an “algorithm type for a redundant array of independent disks”. Exemplarily, the “algorithm type for the redundant array of independent disks” may be, but is not limited to: a RAID0, a RAID1, a RAID5, a RAID6, a RAID10, etc., and redundant algorithms corresponding to different algorithm types for the redundant array of independent disks may be different. For example, for the RAID5, only one redundant data block, i.e., a check data block P Parity, needs to be calculated; while for the RAID6, two redundant data blocks, P Parity and Q Parity, need to be calculated.

Next, the data processor 1802 may pull the stripe data strip by strip from the cache memory by the PNM processor, and may perform the data checking computation for the data block contained in the stripe data pulled strip by strip based on the algorithm type of the checking computation transmitted by the CPU, i.e., the algorithm type for the redundant array of independent disks, to obtain the check data block corresponding to the stripe data pulled strip by strip.

According to an exemplary embodiment of the present disclosure, in a case where the target data processing is the data cloning computation, the data processor 1802 may pull, by the PNM processor, the strip data from the cache memory strip by strip and may perform the data cloning computation for a target data block contained in the strip data pulled strip by strip to obtain a clone data block corresponding to the target data block, i.e., obtain a copy data block corresponding to the target data block. And, the PNM processor may also transmit the clone data block to the cache memory, and thus the cache memory may store the received clone data block in association with the strip data read this time.

According to an exemplary embodiment of the present disclosure, the above data processor 1802 may determine, by the PNM processor, whether there exists expired strip data in the cache memory, wherein the expired strip data is strip data that has not been accessed within a preset first period. In a case where it is determined that there exists the expired strip data, the data processor 1802 may delete the expired strip data from the cache memory and may retain a check data block corresponding to the expired strip data in the cache memory.

According to an exemplary embodiment of the present disclosure, a cache bitmap value of the deleted strip data may also be modified from a first value to a second value. For example, the first value may be 1; the second value may be 0. Herein, the first value may be used to indicate that the strip data exists in a strip cache and the second value may be used to indicate that the strip data does not exist in the strip cache.

In this way, in a case where it is determined that strip data of a certain strip stored in the cache memory has expired, the strip data may be deleted from the cache memory, which in turn may avoid excessive occupation of the cache memory by invalid strip data that has not been accessed for a long period. Further, after the strip data is deleted, the cache bitmap value corresponding to the deleted strip data may be synchronously updated, so that it is easy to determine whether the corresponding strip data exists in the strip cache directly based on the updated cache bitmap value during the subsequent query process, which may improve the query efficiency of the strip data.

According to an exemplary embodiment of the present disclosure, the above cache memory may include a first cache area and a second cache area. Herein, the first cache area may be used to store strip data and a check data block thereof, and the second cache area may be used to store a check data block of deleted strip data. Furthermore, the “first cache area” may be called as the strip cache, and the “second cache area” may be called as a redundant cache or a parity cache.

The above data processor 1802 may delete the expired strip data from the first cache area, and may move the check data block of the expired strip data from the first cache area to the second cache area for storage. That is, the check data block corresponding to the deleted strip data stored in the strip cache may be moved to the redundant cache by the PNM processor. That also is, in the strip cache, if the hotness of the cached content decreases, only the redundant data block of the cached content may be retained and may be evicted to the redundant cache contained in the cache memory.

It should be noted that reading data from the cache memory takes less time than reading data from the SSD. Therefore, by moving the check data block corresponding to the deleted strip data into the redundant cache, it is convenient that in a subsequent data writing scenario, that is, a subsequent data modification scenario, the check data block may be read directly from the redundant cache contained in the cache memory, thereby avoiding the problem of long reading time brought by reading the check data block directly from the SSD, and improving the efficiency of reading the check data block.

According to an exemplary embodiment of the present disclosure, the above data processor 1802 may also determine, by the PNM processor, whether there exists an expired check data block in the second cache area. Herein, the expired check data block may be is a check data block that has not been accessed within a preset second period. In a case where it is determined that there exists the expired check data block, the expired check data block may be deleted from the second cache area. That is, in the redundant cache (parity cache), if a cache item stored therein becomes cold, the cache item may be directly deleted.

It should be noted that in the present disclosure, for hot strip data, it may be stored in the strip cache; for strip data that is not so hot, i.e., for “warm” strip data, only a check data block corresponding to the “warm” strip data may be stored in the redundant cache (parity cache); and for cold strip data, it may be stored directly in the SSD.

In this way, compared to directly caching the strip data in the stripe cache, only caching the check data block corresponding to the strip data in the redundant cache may reduce the occupation of the cache space to a larger extent; moreover, if a certain one of cache items in the redundant cache becomes cold, it may be deleted directly, which may avoid the excessive occupation of the redundant cache by the invalid check data block that is not accessed for a long period. Further, because the check data block exists separately in the redundant cache, it is convenient to subsequently read the check data block directly from the redundant cache, i.e., it improves the cache hit rate that may read the check data block directly from the redundant cache, thus avoiding the problem of long reading time brought by reading the check data block directly from the SSD, and improving the reading efficiency of the check data block. As may be seen, the redundant cache set in the cache memory of the present disclosure better realizes a balance between the cache space occupation and the cache hit rate.

According to an exemplary embodiment of the present disclosure, the above data processing apparatus 1800 may further include a packing processor 1804 (also referred to as packing module) and a writing processor 1805 (also referred to as writing module).

The packing processor may pack, by the PNM processor, all the strip data and all data processing results thereof to obtain packed data, and transmit the packed data to the central processing unit. The writing processor (also referred to as writing module) may then write, by the central processing unit, the packed data into a storage device of the host associated with the PNM device, e.g., to the SSD of the host. That is, in a writing scenario, the cache strip may be packed into a larger data block and written to the storage device (SSD) of the host. It will be understood by a person of skill in the art that one or more components and/or functions of the data processing apparatus 1800 may be performed by one or more processors, individually or in combination, and these processor may be implemented by either a hardware processor including an internal memory or a software module stored in an internal or external storage device loaded on to the internal memory and executed by the data processor 1802 to performed the functions described herein. As a non-limiting example, the data processor 1802 may perform operations and/or functions associated with pulling processor 1801, receiving processor 1803, packing processor 1804, and writing processor 1805. In a same or different embodiment, data processor 1802 may be a single processor or a plurality of processors performing operations and/or functions individually or in combination.

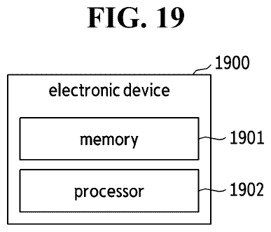

FIG. 19 is a block diagram illustrating an electronic device 1900 according to an exemplary embodiment of the present disclosure.

Referring to FIG. 19, the electronic device 1900 includes at least one memory 1901 and at least one processor 1902, the at least one memory 1901 has instructions stored therein, which, when executed by the at least one processor 1902, perform the data processing method according to exemplary embodiments of the present disclosure.

As an example, the electronic device 1900 may be a PC computer, a tablet device, a personal digital assistant, a smart phone, or any other device capable of executing the above instructions. Here, the electronic device 1900 does not have to be a single electronic device, but may also be any set of devices or circuits capable of executing the above instructions (or instruction set) individually or jointly. The electronic device 1900 may also be a part of an integrated control system or system manager, or may be configured as a portable electronic device that interfaces locally or remotely (e.g., via wireless transmission).

In the electronic device 1900, the processor 1902 may include a central processing unit (CPU), a graphics processor (GPU), a programmable logic device, a dedicated processor system, a microcontroller, or a microprocessor. By way of example and not limitation, the processor may also include an analog processor, a digital processor, a microprocessor, a multi-core processor, a processor array, a network processor, and the like.

The processor 1902 may run instructions or code stored in the memory 1901, wherein the memory 1901 may also store data. The instructions and data may also be transmitted and received over a network via a network interface device, wherein the network interface device may utilize any known transmission protocol.

The memory 1901 may be integrated with the processor 1902, e.g., a RAM or flash memory is arranged within an integrated circuit microprocessor or the like. Additionally, the memory 1901 may include a separate device such as an external disk drive, storage array, or any other storage device that may be used by a database system. The memory 1901 and the processor 1902 may be operatively coupled, or may communicate with each other, e.g., through I/O ports, network connections, etc., to enable the processor 1902 to read files stored in the memory 1901.

In addition, the electronic device 1900 may also include video displays (e.g. liquid crystal display) and user interaction interfaces (e.g. keyboard, mouse, touch input device, etc.). All components of the electronic device 1900 may be connected to each other via a bus and/or a network.

According to an exemplary embodiment of the present disclosure, a computer readable storage medium is also provided. Instructions in the computer readable storage medium, when executed by a processor of an electronic device, cause the processor to perform the above data processing method. Examples of computer-readable storage media herein include: Read Only Memory (ROM), Random Access Programmable Read Only Memory (RAPROM), Electrically Erasable Programmable Read Only Memory (EEPROM), Random Access Memory (RAM), Dynamic Random Access Memory (DRAM), Static Random Access Memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue-ray or optical disk storage, Hard Disk Drive (HDD), Solid State Drive (SSD), card storage (such as multimedia cards, secure digital (SD) cards or extremely fast digital (XD) cards), magnetic tapes, floppy disks, magneto-optical data storage devices, optical data storage devices, hard disks, solid state disks, and any other devices that are configured to store computer programs and any associated data, data files and data structures in a non-transitory manner and provide the computer programs and any associated data, data files and data structures to a processor or computer so that the processor or computer can execute the computer programs. The instructions or computer programs in the computer-readable storage medium described above may be executed in an environment deployed in a computer device. In addition, in one example, the computer programs and any associated data, data files, and data structures are distributed on a networked computer system, so that the computer programs and any associated data, data files, and data structures are stored, accessed and executed through one or more processors or computers in a distributed manner.

According to an exemplary embodiment of the present disclosure, there is provided a computer program product including a computer program, wherein the computer program, when executed by a processor, implements the data processing method according to the present disclosure.

The data processing method and the device thereof provided by the present disclosure enable a PNM processor directly pull strip data from a cache memory strip by strip and perform target data processing by setting the cache memory in the PNM device. Since a distance between the PNM processor and the cache memory is smaller than a distance between the central processing unit and the memory of the central processing unit, reading data from the cache memory by the PNM processor may take less time than reading data from the memory of the central processing unit through the central processing unit, which in turn may improve the overall data processing efficiency. Further, the occupancy rate of the central processing unit may be reduced by moving the time-consuming and intensive data processing process from the central processing unit to the PNM processor, thereby releasing the computing power of the central processing unit.

According to an exemplary embodiment of the present disclosure, in a case where it is determined that strip data of a certain strip stored in the strip cache has expired, the strip data may be deleted from the strip cache, which in turn may avoid excessive occupation of the strip cache by invalid strip data that has not been accessed for a long period. Further, after the strip data is deleted, the cache bitmap value corresponding to the deleted strip data may be synchronously updated, so that it is easy to determine whether the corresponding strip data exists in the strip cache directly based on the updated cache bitmap value during the subsequent query process, which may improve the query efficiency of the strip data.

According to an exemplary embodiment of the present disclosure, reading data from the cache memory takes less time than reading data from the SSD. Therefore, by moving the check data block corresponding to the deleted strip data into the redundant cache, it is convenient that in a subsequent data writing scenario, that is, a subsequent data modification scenario, the check data block may be read directly from the redundant cache contained in the cache memory, thereby avoiding the problem of long reading time brought by reading the check data block directly from the SSD, and improving the efficiency of reading the check data block.

According to an exemplary embodiment of the present disclosure, compared to directly caching the strip data in the stripe cache, only caching the check data block corresponding to the strip data in the redundant cache may reduce the occupation of the cache space to a larger extent; moreover, if a certain one of cache items in the redundant cache becomes cold, it may be deleted directly, which may avoid the excessive occupation of the redundant cache by the invalid check data block that is not accessed for a long period. Further, because the check data block exists separately in the redundant cache, it is convenient to subsequently read the check data block directly from the redundant cache, i.e., it improves the cache hit rate that may read the check data block directly from the redundant cache, thus avoiding the problem of long reading time brought by reading the check data block directly from the SSD, and improving the reading efficiency of the check data block. As may be seen, the redundant cache set in the cache memory of the present disclosure better realizes a balance between the cache space occupation and the cache hit rate.

At least one of the components, elements, modules and units (collectively “components” in this paragraph) represented by a block in the drawings such as FIGS. 1, 9 and 10 may use a direct circuit structure, such as a memory, a processor, a logic circuit, a look-up table, etc. that may execute the respective functions through controls of one or more microprocessors or other control apparatuses. Also, at least one of these components may be specifically embodied by a module, a program, or a part of code, which contains one or more executable instructions for performing specified logic functions, and executed by one or more microprocessors or other control apparatuses. Further, at least one of these components may include or may be implemented by a processor such as a central processing unit (CPU), a microprocessor, or the like that performs the respective functions.

After considering the specification and the practice of the invention disclosed herein, those skilled in the art will readily conceive of other implementations of the present disclosure. The present disclosure is intended to cover any variation, use or adaptation of the present disclosure that follows the general principles of the present disclosure and includes the common knowledge or customary technical means in the field of technology not disclosed by the present disclosure. The specification and embodiments are deemed to be exemplary only, and the true scope and spirit of the present disclosure are indicated by the appended claims.

It should be understood that the present disclosure is not limited to the precise structure already described above and shown in the attached drawings and is subject to various modifications and changes within its scope. The scope of the present disclosure is limited only by the attached claims.

What is claimed is:

1. A data processing method, executed by one or more processors of a processing near memory (PNM) device, wherein the PNM device comprises a PNM processor and a cache memory, the data processing method comprising:
pulling, from a memory of a central processing unit of a host associated with the PNM device, strip data related to target data processing and storing the strip data in the cache memory;
and pulling, from the cache memory, the strip data strip by strip, and performing the target data processing.

2. The data processing method of claim 1, wherein the pulling the strip data from the memory is performed based on the target data processing being an intensive computation for a redundant array of independent disks, and
wherein the intensive computation for the redundant array of independent disks is a computation in which a size of computational resources of the central processing unit required to be occupied exceeds a preset resource size.

3. The data processing method of claim 2, wherein the intensive computation for the redundant array of independent disks comprises at least one of a data checking computation, a data cloning computation, and a data modification computation.

4. The data processing method of claim 3, wherein based on the target data processing being the data checking computation, the performing the target data processing comprises:
performing the data checking computation for a data block contained in the strip data that is pulled strip by strip to obtain a check data block corresponding to the strip data that is pulled strip by strip.

5. The data processing method of claim 4, further comprising:
receiving an algorithm type regarding the data checking computation transmitted by the central processing unit;
wherein the performing the data checking computation for the data block contained in the strip data that is pulled strip by strip to obtain the check data block corresponding to the strip data that is pulled strip by strip comprises:
performing, based on the algorithm type of the data checking computation, the data checking computation for the data block contained in the strip data that is pulled strip by strip to obtain the check data block corresponding to the strip data that is pulled strip by strip.

6. The data processing method of claim 3, wherein based on the target data processing being the data cloning computation, the performing the target data processing comprises:
performing the data cloning computation for a target data block contained in the strip data that is pulled strip by strip to obtain a clone data block corresponding to the target data block.

7. The data processing method of claim 1, further comprising:
determining whether there exists expired strip data in the cache memory, wherein the expired strip data is the strip data that has not been accessed within a preset first period; and
based on determining that there exists the expired strip data, deleting the expired strip data from the cache memory and retaining a check data block associated with the expired strip data in the cache memory.

8. The data processing method of claim 7, wherein the cache memory comprises a first cache area used to store the strip data and a check data block associated with the strip data, and a second cache area used to store a check data block associated with deleted strip data; and
wherein the deleting the expired strip data from the cache memory and retaining the check data block associated with the expired strip data in the cache memory comprises:
deleting the expired strip data from the first cache area and moving the check data block associated with the expired strip data from the first cache area to the check data block associated with deleted strip data in the second cache area for storage.

9. The data processing method of claim 8, further comprising:
determining whether there exists an expired check data block in the second cache area, wherein the expired check data block is an unaccessed check data block that has not been accessed within a preset second period; and
based on determining that there exists the expired check data block, deleting the expired check data block from the second cache area.

10. The data processing method of claim 1, further comprising:
packing the strip data and results of data processing associated with the strip data to obtain packed data, and transmitting the packed data to the central processing unit; and
writing, by the central processing unit, the packed data into a storage device of the host associated with the PNM device.

11. A data processing apparatus applied to a processing near memory (PNM) device, wherein the data processing apparatus comprises:
a pulling processor configured to pull, from a memory of a central processing unit of a host associated with the PNM device, strip data related to target data processing and store the strip data in a cache memory; and
a data processor configured to pull the strip data from the cache memory strip by strip and perform the target data processing.

12. The data processing apparatus of claim 11, wherein the pulling the strip data from the memory is performed based on the target data processing being an intensive computation for a redundant array of independent disks, and
wherein the intensive computation for the redundant array of independent disks is a computation in which a size of computational resources of the central processing unit required to be occupied exceeds a preset resource size.

13. The data processing apparatus of claim 12, wherein the intensive computation for the redundant array of independent disks comprises at least one of a data checking computation, a data cloning computation, and a data modification computation.

14. The data processing apparatus of claim 13, wherein based on the target data processing being the data checking computation, the data processor is configured to:
perform the data checking computation for a data block contained in the strip data that is pulled strip by strip to obtain a check data block corresponding to the strip data that is pulled strip by strip.

15. The data processing apparatus of claim 14, further comprising:
a receiving processor configured to receive an algorithm type regarding the data checking computation transmitted by the central processing unit; and
wherein the data processor is configured to:
perform, based on the algorithm type of the data checking computation, the data checking computation for the data block contained in the strip data that is pulled strip by strip to obtain the check data block corresponding to the strip data that is pulled strip by strip.

16. The data processing apparatus of claim 13, wherein based on the target data processing being the data cloning computation, the data processor is configured to:
perform the data cloning computation for a target data block contained in the strip data that is pulled strip by strip to obtain a clone data block corresponding to the target data block.

17. The data processing apparatus of claim 11, wherein the data processor is further configured to:
determine whether there exists expired strip data in the cache memory, wherein the expired strip data is strip data that has not been accessed within a preset first period; and
based on determining that there exists the expired strip data, delete the expired strip data from the cache memory and retain a check data block associated with the expired strip data in the cache memory.

18. The data processing apparatus of claim 17, wherein the cache memory comprises a first cache area used to store the strip data and a check data block associated with the strip data, and a second cache area used to store a check data block associated with deleted strip data;
wherein the data processor is further configured to:
delete the expired strip data from the first cache area and move the check data block associated with the expired strip data from the first cache area to the check data block associated with deleted strip data in the second cache area for storage.

19. The data processing apparatus of claim 11, further comprising:
a packing processor configured to pack the strip data and results of data processing associated with the strip data to obtain packed data, and transmit the packed data to the central processing unit; and
a writing processor configured to write, by the central processing unit, the packed data into a storage device of the host associated with the PNM device.

20. A processing near memory (PNM) device, comprising:
a PNM processor; and
cache memory;
wherein the cache memory is configured to: store strip data related to target data processing pulled by the PNM processor from a memory of a central processing unit of a host associated with the PNM device, and
wherein the PNM processor is configured to: pull strip data from the cache memory strip by strip and perform the target data processing.
